(19) United States
(12) Patent Application Publication
(10) Pub. No.: US 2005/0204081 A1
(43) Pub. Date: Sep. 15, 2005

(54) [DATA COMPRESSION/DECOMPRESSION DEVICE AND SYSTEM APPLYING THE SAME]

(76) Inventor: William Wang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,609

(22) Filed: May 18, 2004

(30) Foreign Application Priority Data
Mar. 12, 2004 (TW) 93106616

(51) Int. Cl. G06F 13/38

(52) U.S. Cl. 710/68

(57) ABSTRACT

A data compression/decompression device and the system applying the same are provided. The system comprises a data storage device having a data transmission interface; a data generation device accessing a data in the data storage device via the data transmission interface; and a data compression/decompression device, coupled to the data storage device and the data generation device via the data transmission interface, for compressing/decompressing the data transmitted between the data storage device and the data generation device and managing an address mapping table which is the cross reference between an access address transmitted from the data generation device and a physical address of storing the data in the data storage device. Therefore, the object of data compression can be achieved without using the resources of the CPU, the memory space, the related software or driver to compress the data.

### CROSS REFERENCE TO RELATED APPLICATIONS

This application claims the priority benefit of Taiwan application serial no. 93106616, filed Mar. 12, 2004.

### BACKGROUND OF INVENTION

1. Field of the Invention

This invention generally relates to a data compression/decompression device, and more particularly to a data compression/decompression device and the system applying the same without using a central processing unit (CPU) and the memory space.

2. Description of Related Art

As the information technology (IT) advances, the data flow in the IT system continue to grow very fast. Hence, the compressed data is very common in the computer system when processing the data.

FIG. 1 is a view of a traditional computer system storing the data. Referring to FIG. 1, the computer 110 includes a data transmission interface 111 connected to the hard disk drive 120. The computer 110 accesses the data in the hard disk drive 120 via the data transmission interface 111. To increase the storage capacity of the hard disk drive 120, during the process of storing the data in the hard disk drive 120, the compression/decompression program 112 run to compress the data and then the compressed data is stored in the hard disk drive 120. For reading the data in the hard disk drive 120, the compression/decompression program 112 is run to decompress the data and then recover the original data. Although this can increase the storage capacity of the hard disk drive 120, the resources of the CPU and the memory space of the computer 110 are required. In addition, the related software and the driver program in the operation system of the computer 110 need to be established, which is inconvenient to the users.

### SUMMARY OF INVENTION

The present invention is directed to a device for compressing/decompressing the data and the system applying the same without using the resources of the CPU, the memory space, the related software or driver to compress the data, and thereby providing convenience to the users.

The present invention is directed to a system applying data compression/decompression device. According to an embodiment of the present invention, the system comprising data compression/decompression device comprises a data storage device, a data generation device and a data compression/decompression device. The data storage device comprises a data transmission interface. The data generation device is adapted for accessing a data in the data storage device via the data transmission interface. The data compression/decompression device is coupled to the data storage device and the data generation device via the data transmission interface and is adapted for compressing/decompressing the data transmitted between the data storage device and the data generation device and managing an address mapping table which is the cross reference between an access address transmitted from the data generation device and a physical address of storing the data in the data storage device.

According to an embodiment of the present invention, the data compression/decompression device includes an input buffer, an output buffer, a data compressor/decompressor and a controller. The input buffer is adapted for buffering and storing the data for input. The output buffer is adapted for buffering and storing the data for output. The data compressor/decompressor is coupled to the output buffer and is adapted for compressing/decompressing the data for input and storing the data for output in the output buffer. The controller is coupled to the input buffer, the output buffer and the data compressor/decompressor, and is adapted for controlling data transmission with the data generation device and the data storage device, controlling compressing/decompressing the data, and managing the aforementioned address mapping table.

In an embodiment of the present invention, the controller includes a data generation control unit, a data storage control unit, a data extracter and a main controller. The data generation control unit is adapted for controlling data transmission with said data generation device. The data storage control unit is adapted for controlling data transmission with said data storage device. The data extracter is adapted for obtaining the data from the input buffer, extracting a compressing/decompressing portion of the data, and sending the compressing/decompressing portion of the data to the data compressor/decompressor.

The main control unit is adapted for coordinating and controlling the data generation control unit, the data storage control unit and the data extracter, and for managing the address mapping table.

In an embodiment of the present invention, the data generation device is at least one of a host, a laptop computer, a microprocessor, an interface card or a router. The data storage device is at least one of a hard disk drive, a floppy disk drive, a CD-RW drive, a magnetic-optical device, a digital video recorder or a flash memory card.

In light of the above, the device for compressing/decompressing the data according to an embodiment of the present invention can be connected to the data transmission interface between the computer and the hard disk drive to compress/decompress the data and to manage the address mapping table. Therefore, the object of data compression can be achieved without using the resources of the CPU, the memory space, the related software or driver to compress the data, and thereby providing convenience to the users.

The above is a brief description of some deficiencies in the prior art and advantages of the present invention.

Other features, advantages and embodiments of the invention will be apparent to those skilled in the art from the following description, accompanying drawings and appended claims.

### BRIEF DESCRIPTION OF DRAWINGS

FIG. 1 is a view of a traditional computer system used for storing the data.

FIG. 2 is a block diagram of a system applying the data compression/decompression device in accordance with an embodiment of the present invention.

FIG. 3 shows the data compression/decompression device of FIG. 2 disposed inside the data storage device.

FIG. 4 shows the data compression/decompression device of FIG. 2 disposed inside the data generation device.

FIG. 5 is a block diagram of a data compression/decompression device in accordance with an embodiment of the present invention.

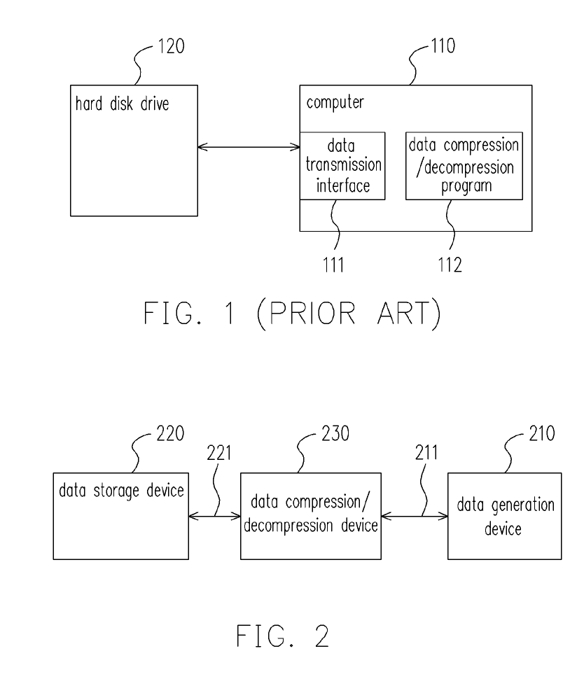

### DETAILED DESCRIPTION

FIG. 2 is a block diagram of a system applying the data compression/decompression device in accordance with an embodiment of the present invention. According to an embodiment of the present invention, the system 200 comprises a data generation device 210, a data storage device 220 and a data compression/decompression device 230.

The data generation device 210 can be one of a host, a laptop computer, a microprocessor, an interface card or a router. The data storage device 220 can be one of a hard disk drive, a floppy disk drive, a CD-RW drive, a magnetic-optical device, a digital video recorder and a flash memory card.

As shown in FIG. 2, the data generation device 210 and the data storage device 220 are coupled to the data compression/decompression device 230 via the data transmission interfaces 211 and 221. Each of the data transmission interfaces 211 and 221 can be one of an IDE interface, a 1394 interface, a SCSI interface, a serial ATA interface, a serial attached SCSI interface, a PCMCIA interface and a USB interface.

When the data generation device 210 accesses the data in the data storage device 220 via the data transmission interfaces 211 and 221, the data compression/decompression device 230 will compress/decompress the data transmitted between the data generation device 210 and the data storage device 220. Because the data transmitted by the data generation device 210 have been compressed, the compressed data will occupy a space smaller than what the data generation device 210 recognizes. Hence, the data compression/decompression device 230 has to manage an address mapping table which is the cross reference between an access address transmitted from the data generation device 210 and a physical address of storing data in the data storage device 220.

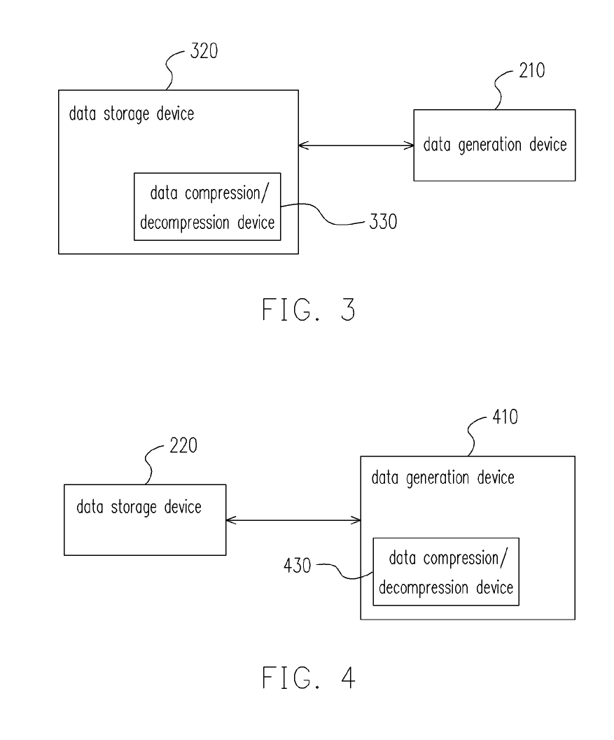

In FIG. 2, although the data generation device 210, the data storage device 220 and the data compression/decompression device 230 are independent, as a practical matter, one can dispose the data compression/decompression device 330 inside the data storage device 320 as shown in FIG. 3, or dispose the data compression/decompression device 430 into the data generation device 410 as shown in FIG. 4.

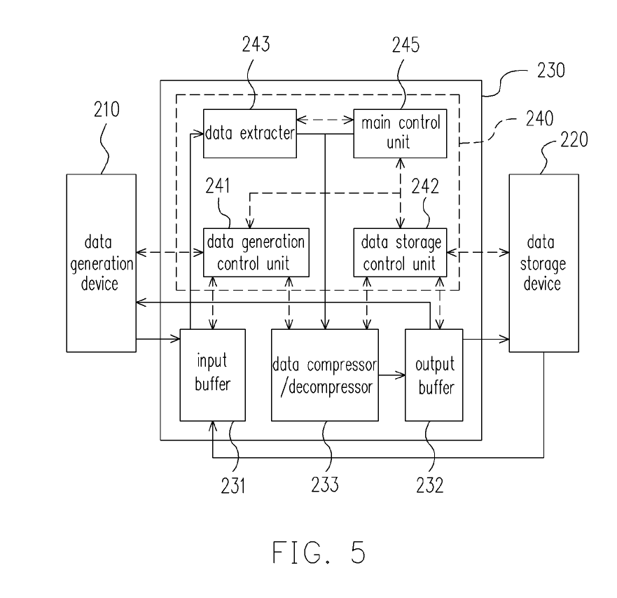

FIG. 5 is a block diagram of the data compression/decompression device in accordance with an embodiment of the present invention. The data compression/decompression device 230 includes an input buffer 231, an output buffer 232, a data compressor/decompressor 233 and a controller 240. The controller 240 includes a data generation control unit 241, a data storage control unit 242, a data extracter 243 and a main control unit 245.

Referring to FIG. 5, the solid line represents the data flow and the hollow line represents the control signal. As shown in FIG. 5, the data generation control unit 241 is adapted for controlling the data transmission between the data compression/decompression device 230 and the data generation device 210. For example, the data generation control unit 241 will control to buffer and store the input data from the data generation device 210 in the input buffer 231, or to extract and send the output data stored in the output buffer 232 to the data generation device 210. The data storage control unit 242 is adapted for controlling the data transmission between the data compression/decompression device 230 and the data storage device 220. For example, the data storage control unit 242 will control to buffer and store the input data from the data storage device 220 in the input buffer 231, or to extract and send the output data stored in the output buffer 232 to the data storage device 220.

In addition, the data extracter 243 retrieves the data from the input buffer 231, extract a compressing/decompressing portion of the data (e.g., the storage address from the data generation device 210 does not require compression and should be separated in advance), and the compressing/decompressing portion of the data is sent to the data compressor/decompressor 233. The data compressor/decompressor 233 compresses/decompresses the data from the data extracter 243 and stores the output data in the output buffer 232. The main control unit 245 is adapted for coordinating and controlling the data generation control unit 241, the data storage control unit 242 and the data extracter 243, and also for managing an address mapping table which is the cross reference between an access address transmitted from the data generation device 210 and a physical address of storing data in the data storage device 220, in order to achieve the object of data compression.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A data compression/decompression device, suitable for compressing/decompressing a data transmitted between a data generation device and a data storage device, comprising:
an input buffer, for buffering and storing said data for input;
an output buffer, for buffering and storing said data for output;
a data compressor/decompressor, coupled to said output buffer, for compressing/decompressing said data for input and storing said data for output in said output buffer; and
a controller, coupled to said input buffer, said output buffer and said data compressor/decompressor, for controlling data transmission with said data generation device and said data storage device, controlling compressing/decompressing said data, and managing an address mapping table which is the cross reference between an access address transmitted from said data generation device and a physical address of storing the data in said data storage device.

2. The device of claim 1, wherein said controller includes:
a data generation control unit, for controlling data transmission with said data generation device;
a data storage control unit, for controlling data transmission with said data storage device;
a data extracter, for obtaining said data from said input buffer, extracting a compressing/decompressing portion of said data, and sending said compressing/decompressing portion of said data to said data compressor/decompressor; and
a main control unit, for coordinating and controlling said data generation control unit, said data storage control unit, and said data extracter, and for managing said address mapping table.

3. The device of claim 1, wherein said data generation device is at least one of a host, a laptop computer, a microprocessor, an interface card and a router.

4. The device of claim 1, wherein said data storage device is at least one of a hard disk drive, a floppy disk drive, a CD-RW drive, a magnetic-optical device, a digital video recorder and a flash memory card.

5. A system applying a data compression/decompression device, comprising:
a data storage device, having a data transmission interface;
a data generation device, accessing a data in said data storage device via said data transmission interface; and
a data compression/decompression device, coupled to said data storage device and said data generation device via said data transmission interface, for compressing/decompressing said data transmitted between said data storage device and said data generation device and managing an address mapping table which is the cross reference between an access address transmitted from said data generation and a physical address of storing said data in said data storage device.

6. The device of claim 5, wherein said data compression/decompression device includes:
an input buffer, for buffering and storing said data for input;
an output buffer, for buffering and storing said data for output;
a data compressor/decompressor, coupled to said output buffer, for compressing/decompressing said data for input and storing said data for output in said output buffer; and
a controller, coupled to said input buffer, said output buffer, and said data compressor/decompressor, for controlling data transmission with said data generation device and said data storage device, controlling compressing/decompressing said data, and managing said address mapping table.

7. The system of claim 6, wherein said controller includes:
a data generation control unit, for controlling data transmission with said data generation device;
a data storage control unit, for controlling data transmission with said data storage device;
a data extracter, for obtaining said data from said input buffer, extracting a compressing/decompressing portion of said data, and sending said compressing/decompressing portion of said data to said data compressor/decompressor; and
a main control unit, for coordinating and controlling said data generation control unit, said data storage control unit, and said data extracter, and for managing said address mapping table.

8. The system of claim 5, wherein said data generation device is at least one of a host, a laptop computer, a microprocessor, an interface card and a router.

9. The system of claim 5, wherein said data storage device is at least one of a hard disk drive, a floppy disk drive, a CD-RW drive, a magnetic-optical device, a digital video recorder and a flash memory card.

10. The system of claim 5, wherein said data transmission interface is one of an IDE interface, a 1394 interface, a SCSI interface, a serial ATA interface, a serial attached SCSI interface, a PCMCIA interface and a USB interface.
